(19) United States
(12) Patent Application Publication
(10) Pub. No.: US 2012/0275413 A1
(43) Pub. Date: Nov. 1, 2012

(54) METHOD FOR ALLOCATING AND TRANSMITTING RESOURCES IN A WIRELESS COMMUNICATION SYSTEM, TRANSMITTING APPARATUS FOR SAME, AND RECEIVING APPARATUS CORRESPONDING TO SAME

(75) Inventors: Sungkwon Hong, Seoul (KR); Sungjin Suh, Seoul (KR); Sungjun Yoon, Seoul (KR)

(73) Assignee: PANTECH CO., LTD., Seoul (KR)

(21) Appl. No.: 13/520,748

(22) PCT Filed: Jan. 4, 2011
(86) PCT No.: PCT/KR11/00029

§ 371 Date: Jul. 5, 2012

(30) Foreign Application Priority Data
Jan. 5, 2010 (KR) 10-2010-0000648
May 7, 2010 (KR) 10-2010-0043233

(51) Int. Cl. H04W 72/04

(52) U.S. Cl. 370/329

(57) ABSTRACT

The present description discloses a method for allocating resources in a wireless communication system, and an apparatus and system for same.

### CROSS-REFERENCE TO RELATED APPLICATIONS

This application claims is the National Stage entry of International Application PCT/KR2011/000029, filed on Jan. 4, 2011, and claims priority from and the benefit of Korean Patent Application No. 10-2010-0000648, filed on Jan. 5, 2010, and Korean Patent Application No. 10-2010-0043233, filed on May 7, 2010, all of which are incorporated herein by reference for all purposes as if fully set forth herein.

### BACKGROUND

1. Field

The present invention relates to a method and an apparatus for allocating resources in a wireless communication system and a system thereof.

2. Discussion of the Background

In a wireless communication system, one of basic principles of a wireless connection may be transmission over a shared channel, namely, dynamically sharing of time-frequency resources among user equipments. At this time, a base station can control the allocation of uplink resources and downlink resources.

Particularly, the base station provides information on the allocation of uplink resources to a user equipment, and the user equipment first allocates a resource based on the information and then transmits data in uplink through the allocated resource.

### SUMMARY

In order to accomplish the above-mentioned objects, in accordance with an aspect of the present invention, there is provided a method for allocating resources by a base station. The method includes: non-contiguously allocating resources of a k (k is a natural number equal to or greater than 2) number of clusters each including one or more resource block groups among all resource block groups to a particular user equipment in a wireless communication system; and generating a message indicating a k number of non-contiguous clusters by using at least one offset and one of at least one length of a resource block group and at least one different offset.

In accordance with another aspect of the present invention, there is provided method for allocating resources by a base station. The method includes: contiguously or non-contiguously allocating resources of a k (k is a natural number equal to or greater than 2) number of clusters each including one or more resource block groups among all resource block groups to a particular user equipment in a wireless communication system; and transmitting information on contiguous or non-contiguous resource allocation, which is constructed by one number system, through a control channel.

### BRIEF DESCRIPTION OF THE DRAWINGS

FIG. 1 is a view schematically showing the configuration of a wireless communication system to which embodiments of the present invention are applied.

FIG. 2 is a view showing the concept of a method for allocating resources according to an embodiment of the present invention.

FIG. 3 is a view illustrating coefficients for expressing the allocation of non-contiguous resources having two clusters used for a method for allocating non-contiguous resources according to another embodiment of the present invention.

FIG. 4 is a view showing a concept expressing two clusters shown in (c) of FIG. 3 by using four coefficients.

FIG. 5 is a view illustrating coefficients for expressing the allocation of non-contiguous resources having three clusters used for a method for allocating non-contiguous resources according to still another embodiment of the present invention.

FIG. 6 is a view showing a concept expressing three clusters shown in FIG. 4 by using six coefficients

FIG. 7 is a view showing an example of a method for allocating non-contiguous resources according to still another embodiment of the present invention.

FIG. 8 is a view showing a concept expressing a k number of clusters by using a 2k number of coefficients.

FIG. 9 is a flowchart showing a method for configuring a PDCCH.

FIG. 10 is a block diagram showing the configuration of a base station according to still another embodiment of the present invention, which generates control information in downlink.

FIG. 11 is a flowchart showing a method for processing a PDCCH.

FIG. 12 is a block diagram showing the configuration of a user equipment according to still another embodiment of the present invention.

FIG. 13 is a view showing a method for allocating non-contiguous resources, which expresses a k number of clusters by combining allocating of a j number of resource regions among a total of n resource block groups after limiting of the range of j and allocating of a (k−1) number of clusters in the range of (j−2).

FIG. 14 is a flowchart showing a process of determining the value of m according to the required number of particular bits when resources of two non-contiguous clusters are allocated.

FIG. 15 is a flowchart showing a process of determining the value of m according to the required number of particular bits when resources of three non-contiguous clusters having such a form that two clusters are combined with three clusters are allocated.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

In this specification, a “resource block group” signifies a set of contiguous resource blocks. For example, a downlink system band including an N_{RB}^{DL} number of resource blocks versus the number of all resource block groups may be given by N_{RB}^{DL}/P. At this time, P may be a natural number equal to or greater than 1, or equal to or greater than 2. Accordingly, a resource block group signifies each resource block when P=1, and a resource block group signifies a set of P resource blocks when P≧2. In the latter case, when the number of resource blocks is 100 and P=4, the number of resource block groups may be 25.

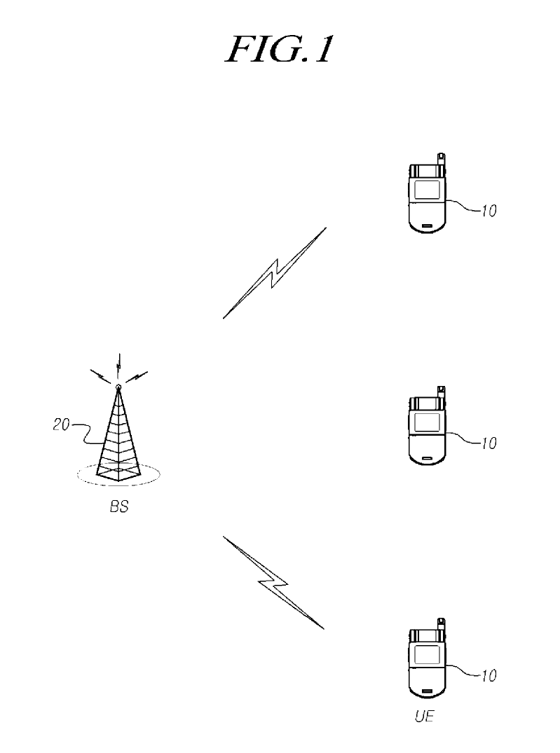

FIG. 1 is a view schematically showing the configuration of a wireless communication system to which embodiments of the present invention are applied.

The wireless communication system is widely arranged in order to provide various communication services, such as voice, packet data, etc.

Referring to FIG. 1, the wireless communication system includes a User Equipment (UE) 10 and a Base Station (BS) 20. The user equipment 10 and the base station 20 use various methods for allocating resources, which will be described below.

In this specification, the User Equipment (UE) 10 has a comprehensive concept implying a user terminal in wireless communication. Accordingly, the UEs should be interpreted as having the concept of including a MS (Mobile Station), a UT (User Terminal), an SS (Subscriber Station), a wireless device, and the like in GSM (Global System for Mobile Communications) as well as UEs (User Equipments) in WCDMA (Wideband Code Division Multiple Access), LTE (Long Term Evolution), HSPA (High Speed Packet Access), etc.

The base station 20 or a cell usually refers to a fixed station communicating with the user equipment 10, and may be called different terms, such as a Node-B, an eNB (evolved Node-B), a BTS (Base Transceiver System), and an AP (Access Point).

Namely, in this specification, the base station 20 or the cell should be interpreted as having a comprehensive meaning indicating a partial area covered by a BSC (Base Station Controller) in CDMA (Code Division Multiple Access) or a Node-B in WCDMA (Wideband Code Division Multiple Access). Accordingly, the base station 20 or the cell has a meaning including various coverage areas such as a mega cell, a macro cell, a micro cell, a pico cell, and a femto cell.

In this specification, the user equipment 10 and the base station 20, which are two transmission and reception subjects used to implement the art or the technical idea described in this specification, are used as a comprehensive meaning, and are not limited by a particularly designated term or word.

There is no limit to multiple access schemes applied to the wireless communication system. For example, use may be made of various multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, and OFDM-CDMA.

In this respect, use may be made of a TDD (Time Division Duplex) scheme in which uplink transmission and downlink transmission are performed at different times. Otherwise, use may be made of an FDD (Frequency Division Duplex) scheme in which uplink transmission and downlink transmission are performed by using different frequencies.

An embodiment of the present invention may be applied to the allocation of resources in asynchronous wireless communications which have gone through GSM, WCDMA and HSPA, and evolve into LTE (Long Term Evolution) and LTE-A (Long Term Evolution-Advanced), and in synchronous wireless communications which evolve into CDMA, CDMA-2000 and UMB. The present invention should not be interpreted as being limited to or restricted by a particular wireless communication field, and should be interpreted as including all technical fields to which the spirit of the present invention can be applied.

Hereinafter, resource allocation will be comprehensively described, and a description will be made of coefficients of Resource Indication Values (RIVs), a method for expressing resource indication values by using these coefficients, a method for transmitting a PDCCH (Physical Downlink Control Channel) through one of messages including these resource indication values, a method for processing a PDCCH, and apparatuses thereof, according to various embodiments of the present invention.

In a wireless communication system, one of basic principles of a wireless connection may be transmission over a shared channel, namely, dynamically sharing of time-frequency resources among the user equipments 10. The base station 20 may control the allocation of uplink resources and downlink resources.

In an LTE system corresponding to one of the wireless communication systems, data transmitted in uplink from the user equipment 10 to the base station 20 is carried by a resource block group designated by resource allocation determined by the base station 20, and is transmitted through the resource block group. The base station 20 may notify the user equipment 10 in a DCI (Downlink Control Information) format of a PDCCH corresponding to a control channel in downlink. This resource allocation for a Physical Uplink Shared Channel (PUSCH) is referred to as an “uplink scheduling grant” or is simply referred to as a “PUSCH grant.”

A predetermined field of the DCI format notifies the user equipment 10 of a predetermined area in an uplink frame format which is to be used to carry and transmit data by the user equipment 10. This area is referred to as a “resource allocation field.” Resource allocation designated by a resource allocation field is processed on a per-Resource Block Group (RBG) basis. The resource allocation field in which the contents of resource allocation are expressed by using binary values within a predetermined range in various formats, notifies the user equipment 10 of the contents of the resource allocation.

The user equipment 10 corresponding to a receiver side may interpret the resource allocation field in the detected PDCCH DCI format. The user equipment 10 may interpret the resource allocation field, may allocate a data channel (i.e. resources of a PUSCH), and may transmit data to the base station 20.

Although the method for allocating resources has been described, for example, in the LTE system corresponding to one of the wireless communication systems, the present invention is not limited to this configuration. Accordingly, a specific scheme or configuration of resource allocation is not limited to the LTE system as described above, but should be understood as a scheme or configuration of resource allocation which will be described throughout this specification.

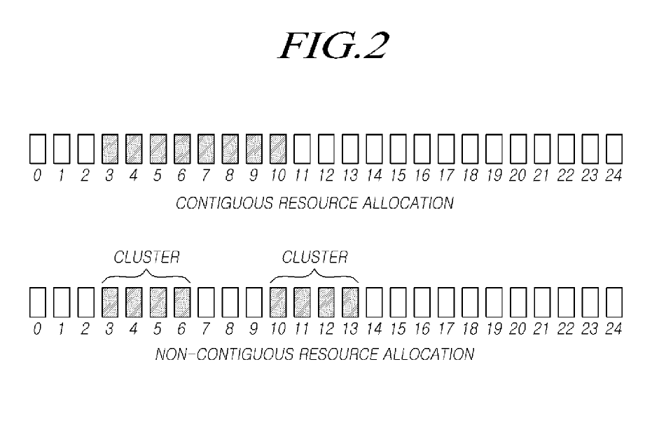

FIG. 2 is a view showing the concept of a method for allocating resources according to an embodiment of the present invention.

In the case of allocating resources in uplink, when the total resources include an n (n=25 in FIG. 2) number of resource block groups as shown in an upper part of FIG. 2, a method for allocating resources according to an embodiment of the present invention may allocate contiguous resource block groups to the user equipment 10. Otherwise, the method may allocate non-contiguous resource block groups to the user equipment 10, as shown in a lower part of FIG. 2. The former is referred to as “contiguous resource allocation,” and the latter is referred to as “non-contiguous resource allocation.” The former can reduce the payload of control information on uplink resource allocation, and the latter has an advantage in terms of efficient resource allocation.

When non-contiguous resources are allocated as shown in the lower part of FIG. 2, each of contiguous resource allocation regions is referred to as a “cluster.”

The base station 20 may allocate non-contiguous resources to the connected user equipments 10, or may allocate contiguous resources to the connected user equipments 10. Meanwhile, the base station 20 may allocate contiguous resources to the particular user equipment 10 while allocating non-contiguous resources to it, or vice versa.

Meanwhile, when the number of clusters is 2 or 3, in the case of non-contiguous resource allocation, it is possible to obtain most of performance gain resulting from the non-contiguous resource allocation. However, the present invention is not limited to this configuration. Accordingly, in terms of the efficiency of resource allocation in contiguous resource allocation, four or more clusters may be used. Hereinafter, although non-contiguous resource allocation will be described, for example, when the number of clusters is 2 or 3, the present invention may be generalized to a case where the number of clusters is k (k is a natural number equal to or greater than 2). At this time, each of clusters includes one or more resource block groups.

Hereinabove, the resource allocation has been comprehensively described, and a resource indication value in the case of contiguous resource allocation will be described below.

Although an uplink scheduling grant or a PUSCH grant may use a DCI format 0 among PDCCH DCI formats corresponding to a control channel, the present invention is not limited to this configuration. For example, in order to support a method for allocating resources according to an embodiment of the present invention, a channel other than a control channel, for example, a data channel may be used for an uplink scheduling grant or a PUSCH grant. Otherwise, even when the control channel is used, a control channel other than a PDCCH may be used. Otherwise, even when the PDCCH is used, a format other than the DCI format 0 or a is newly-defined format may be used. Namely, the schemes as described above may be used even for downlink scheduling for a PDSCH grant. Also, a combination of the schemes as described above may be used.

A control field indicating information on resource allocation of which the base station 20 notifies the user equipment 10, for example, a resource allocation field may express cases where resources can be allocated, by using integer values within a predetermined range. In the case of expressing cases where resources can be allocated, by using integer values within a predetermined range as described above, an integer value within a predetermined range may be referred to as a “Resource Indication Value (RIV).” Hereinafter, an information field that the base station 20 uses to notify the user equipment 10 of information on resource allocation is referred to as a “resource allocation field,” and an integer value within a predetermined range is referred to as a “resource indication value.” However, the present invention is not limited to these terms.

A resource allocation field in the case of contiguous resource allocation as shown in the upper part of FIG. 2 may include a resource indication value RIV_{LTE}(L_{CRBs}, RBₛₜₐᵣₜ, N_{RB}^{DL}) indicating a start point of a resource block group (namely, a starting resource block RBₛₜₐᵣₜ) and the length of contiguous virtual resource blocks (namely, a length L_{CRBs} in terms of virtually contiguously-allocated resource blocks). At this time, RIV_{LTE}(L_{CRBs}, RBₛₜₐᵣₜ, N_{RB}^{DL}) may be expressed by equation (1) below.

if (L_{CRBs}−1)≦└N_{RB}^{DL}/2┘ then

RIV_{LTE}(L_{CRBs},RBₛₜₐᵣₜ,N_{RB}^{DL})=N_{RB}^{DL}(L_{CRBs}−1)+RBₛₜₐᵣₜ

else

RIV_{LTE}(L_{CRBs},RBₛₜₐᵣₜ,N_{RB}^{DL})=N_{RB}^{DL}(N_{RB}^{DL}−L_{CRBs}+1)

+(N_{RB}^{DL}−1−RBₛₜₐᵣₜ) (1)

where L_{CRBs}≧1 and shall not exceed N_{VRB}^{DL}−RBₛₜₐᵣₜ

Herein, └x┘ which signifies the floor of x, represents the largest integer among integers equal to or less than a number within └ ┘. N_{VRB}^{DL} represents a maximum length of a virtual connected resource block groups. N_{RB}^{DL} which represents the number of all resource block groups, corresponds to n. Although “DL” signifies downlink, the meaning of “DL” is not limited only to downlink. Namely, by denoting “UL” instead of “DL” in equation (1), N_{RB}^{DL} or N_{VRB}^{DL} may be replaced by N_{RB}^{UL} or N_{VRB}^{UL}. Also, an “RB” may be replaced by an “RBG.”.

At this time, when the number of all resource block groups is N_{RB}^{DL}, the resource indication value RIV_{LTE}(L_{CRBs}, RBₛₜₐᵣₜ, N_{RB}^{DL}) indicating the starting resource block RBₛₜₐᵣₜ and the length L_{CRBs} in terms of virtually contiguously-allocated resource blocks, as described) above, has a value from “0” to

$$\frac{{N}_{RB}^{DL} ( {N}_{RB}^{DL} + 1 )}{2} - 1.$$

When N_{RB}^{DL}=n=25, RIV_{LTE} (L_{CRBs}, RBₛₜₐᵣₜ, N_{RB}^{DL}) has a value from “0” to “324.”

In an example of the contiguous resource allocation as shown in the upper part of FIG. 2 where RBₛₜₐᵣₜ=3 and L_{CRBs}=8 when the number of all resource block groups is 25, RIV_{LTE}(L_{CRBs}, RBₛₜₐᵣₜ, N_{RB}^{DL})=N_{RB}^{DL}(L_{CRBs}−1)+RBₛₜₐᵣₜ=178.

A method for interpreting a resource allocation field in a detected PDCCH DCI format 0 and decoding a resource indicator by the user equipment 10 corresponding to a receiver side will be described below.

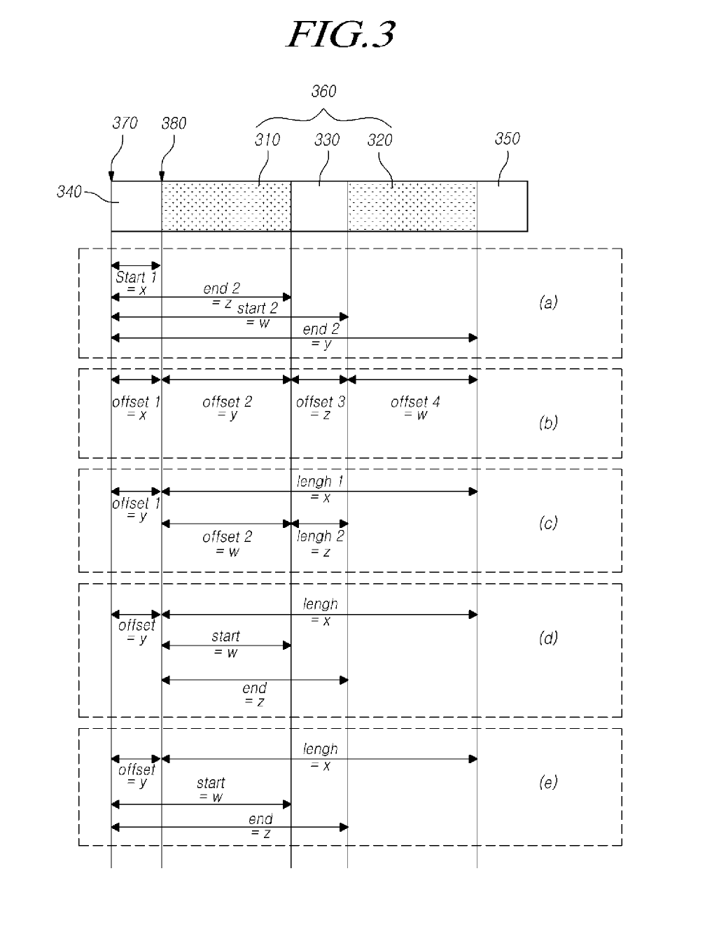

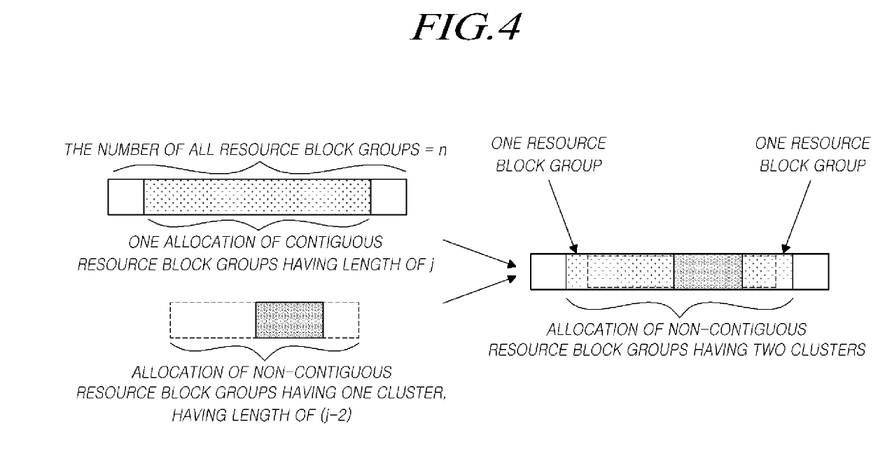

The user equipment 10 corresponding to a receiver side detects the value of RIV (=178) from the resource allocation field in the detected PDCCH DCI format 0. L_{CRBs} (=8) is obtained from a value obtained by adding 1 to the quotient (7) of RIV divided by N_{RB}^{DL} (=25). Then, RBₛₜₐᵣₜ (=3) is obtained from a remainder (=3). Hereinabove, the resource indication value in the case of the contiguous resource allocation has been described. Next, a resource indicator in a method for allocating resources of two non-contiguous clusters will be described. At this time, coefficients of resource indicators in a method for allocating resources of two non-contiguous clusters will be described with reference to (a) to (e) in FIG. 3, and a concept expressing two clusters shown in (c) of FIG. 3 by using four coefficients will be described below with reference to FIG. 4.

When non-contiguous resources are allocated, a resource allocation field may include a resource indicator expressed by using various coefficients in order to express two or more clusters.

FIG. 3 is a view illustrating coefficients for expressing the allocation of non-contiguous resources having two clusters used for a method for allocating non-contiguous resources according to another embodiment of the present invention. As shown in FIG. 3, instead of separately showing resource block groups as in FIG. 2, the resource block groups are expressed in such a manner as to divide all the resource block groups into regions 310 and 320 of resource block groups allocated as resources and regions 330, 340 and 350 of resource block groups which are not allocated as resources. The regions 310 and 320 of resource block groups allocated as resources signify the clusters as described above.

Referring to (a) in FIG. 3, when non-contiguous resources are allocated, a resource allocation field may include a resource indicator RIV indicating a start point of a resource block group (i.e. a starting resource block) of a first cluster 310 and an end point of a resource block group (i.e. an ending resource block) thereof, and a start point of a resource block group (i.e. a starting resource block) of a second cluster 320 and an end point of a resource block group (i.e. an ending resource block) thereof.

Referring to (a) in FIG. 3, coefficients of start points and end points of the two non-contiguous clusters 310 and 320 for expressing the resource allocation field in the case of the non-contiguous resource allocation may be expressed as x, y, z and w. At this time, the range of each of x, y, z and w is limited such that a coefficient z of the end point of the first configured cluster 310 and a coefficient w of the start point of the next configured cluster 320 have a difference therebetween, the value of which is at least two (such that the length of a non-contiguous part between the first cluster and the second cluster is equal to or greater than 1). The start point x of the first cluster 310 may have a value identical to that of the start point w of the second cluster 320. Also, the end point z of the first cluster 310 may have a value identical to that of the end point y of the second cluster 320.

Referring to (b) in FIG. 3, a resource allocation field in the case of the non-contiguous resource allocation may include a resource indicator RIV indicating four offset values for the two non-contiguous clusters 310 and 320. At this time, a first offset from a start point of all the resource block groups may represent the start of the first cluster 310, and a second offset therefrom may represent the end of the first cluster 310. Similarly, third and fourth offsets therefrom may represent the start and end of the second cluster 320, respectively.

According to principles, each offset is given with the end of an offset just before it as reference and the range of each offset starts from 0. However, the value of a third offset must be equal to or greater than “1.” In this configuration scheme, by adding two offset coefficients for each cluster, a k number of typical clusters may be expressed.

Referring to (c) in FIG. 3, a resource allocation field in the case of the non-contiguous resource allocation may include a resource indicator RIV indicating an offset y of resource block groups within an entire region 360 including the two clusters 310 and 320 and a region 330 of resource block groups between the two clusters 310 and 320, which are not allocated as resources, a length x of the entire region 360, and another offset w and a length z of the region 330 of resource block groups between the two clusters 310 and 320, which are not allocated as resources.

FIG. 4 is a view showing a concept expressing two clusters shown in (c) of FIG. 3 by using four coefficients. In this regard, for the clearness of the drawings, reference numerals used in FIG. 3 will not be shown in FIG. 4.

Referring to FIG. 4, when the number of all resource block groups is n, the indication of two clusters may be expressed by contiguous resource block groups which have a length of j, include contiguous resource block groups which have a length of (j−2) and include one non-allocated region. This expression signifies that it is possible to allocate a non-allocated region between two clusters within contiguous resource block groups, which have a length of (j−2), included in contiguous resource block groups which have a length of j.

Referring mainly to FIG. 4 together with (c) in FIG. 3, the contiguous resource block groups which have a length of j (reference numeral 360 in FIG. 3) are expressed by the offset y and the length x of the contiguous resource block groups 360 which have a length of j, as shown in (c) of FIG. 3, similarly to the resource indication value RIV of the resource allocation field in the case of the contiguous resource allocation which has been described with reference to the upper part of FIG. 2. Meanwhile, the non-allocated region 330 between the clusters 310 and 320 included in the contiguous resource block groups 360 which have a length of j, is expressed by another offset w and the length z of the region of resource block groups between the two clusters 310 and 320, which are not allocated as resources. At this time, in order to express, to a minimum (a length is “1”), the region 330 of non-allocated resource block groups between the two clusters, the value of the offset w is given a value by considering a value (x+1), which is greater by “1” than the value of the first offset y, as “0” corresponding to a start point.

In other words, the coefficient y is a start point (i.e. offset) of a first resource block group among the contiguous resource block groups 360; x is the number of the contiguous resource block groups 360 (namely, the sum of the number of resource block groups of the two clusters and the number of resource block groups between the two clusters, which are not allocated as resources); w is considered as a start point of the resource block groups between the two clusters, which are not allocated as resources, when resource block groups, the number of which is (x+1), are indexed as “0”; and z is the number of the resource block groups between the two clusters, which are not allocated as resources.

In an example of the non-contiguous resource allocation as shown in the lower part of FIG. 2, when the number of all resource block groups is 25, y=3, x=11, w=3, and z=3.

When it is assumed that values are given in the order of x (x=3, . . . , n), y (y=0, . . . , n-x), z (z=1, . . . , x−2), and w (w=0, . . . , x-z−2) for resource allocation, a resource indicator RIV of a resource allocation field in the case of allocating non-contiguous resources in the scheme as shown in (c) of FIG. 3 and FIG. 4, may be expressed by equation (2) below. However, the present invention is not limited to this configuration.

RIV(2)=RIV₁(x,n)+RIV₂(x,y)+RIV₃(x,z)+RIV₄(w), and

RIV=0, . . . ,ₙ₋₁C₄−1 (2)

In RIV(2), “2” represents that the number of non-contiguous clusters is 2, and RIV(2) signifies a resource indicator RIV of a resource allocation field in the case of allocating non-contiguous resources of two non-contiguous clusters. Hereinafter, in RIV(x), “x” represents the number of non-contiguous clusters.

In equation (2), RIV₁(x, n) corresponding to a function of x and n is the number of resource allocations, up to (x−1). RIV₂(x, y) corresponding to a function of x and y is the number of resource allocations according to a change in the value of y. RIV₃(x, z) corresponding to a function of x and z is the number of resource allocations, up to (z−1). RIV₄(w) corresponding to a function of w is the number of resource allocations according to a change in the value of w.

RIV₁(x, n), RIV₂(x, y), RIV₃(x, z) and RIV₄(w) are expressed by using n corresponding to the number of all the resource block groups and the four coefficients x, y, w and z, as described above, by equation (3) below.

$$\begin{matrix}\begin{matrix}{RIV}_{1} ( x , n ) = {\sum }_{i = 1}^{x - 1} \frac{( n + 1 - i ) ( {i}^{2} - 3 i + 2 )}{2} \\ = \frac{( x - 1 ) ( \begin{matrix}( 4 n + 19 ) {x}^{2} + 24 ( n + 1 ) - \\ 3 {x}^{3} - ( 20 n + 38 ) x\end{matrix} )}{24} ,\end{matrix} \\ x = 3 , … , n & ( 3 ) \\ {RIV}_{2} ( x , y ) = y {\sum }_{i = 1}^{x - 2} i = \frac{( x - 2 ) ( x - 1 ) y}{2} , y = 0 , … , n - x \\ {RIV}_{3} ( x , z ) = {\sum }_{i = 1}^{z - 1} ( x - 1 - i ) = ( x - 1 ) ( z - 1 ) - \frac{z ( z - 1 )}{2} , \\ z = 1 , … , x - 2 and \\ {RIV}_{4} ( w ) = {\sum }^{w} i = w , w = 0 , … , x - z - 2 & \end{matrix}$$

In an example of the non-contiguous resource allocation as shown in the lower part of FIG. 2 where y=3, x=11, w=3 and z=3 when the number of all resource block groups is 25, RIV₁(x, n)=0, RIV₂(x, y)=11, RIV₃(x, z)=1 and RIV₄(w)=3, and thus RIV(2)=15.

Hereinabove, the resource indicator in the case where the number of non-contiguous clusters is 2 has been described. Hereinafter, decoding of this resource indicator by the user equipment corresponding to a receiver side will be described.

Interpreting of a resource allocation field in a detected PDCCH DCI format 0 and decoding of a resource indicator by the user equipment 10 corresponding to a receiver side is expressed as follows:

1) When the number of resource block groups is n, values of RIV₁(3, n), . . . , RIV₁(n, n) are stored.

2) x_{rcv} satisfying RIV₁(x_{rcv}, n)≦RIV_{rcv}<RIV₁(x_{rcv}+1, n) in RIV₁(3, n), . . . , RIV₁(n, n) is calculated by using the received RIV_{rcv}.

3) y_{rcv} satisfying RIV₂(x_{rcv}, y_{rcv})≦RIV_{rcv}−RIV₁(x_{rcv}, n)<RIV₂(x_{rcv}, y_{rcv}+1) is calculated.

4) z_{rcv} satisfying w_{rcv}=RIV_{rcv}−RIV₁(x_{rcv}, n)−RIV₂(x_{rcv}, y_{rcv})−RIV₃(x_{rcv}, z_{rcv}) is calculated.

5) w_{rcv}=RIV_{rcv}−RIV₁(x_{rcv}, n)−RIV₂(x_{rcv}, y_{rcv})−RIV₃(x_{rcv}, z_{rcv}) is calculated.

The coefficients x, y, z and w of start points and end points of the two non-contiguous clusters 310 and 320, which express the resource indicator of the resource allocation field in the case of the non-contiguous resource allocation as shown in (a) of FIG. 3, or the four offset values expressing the resource indicator of the resource allocation field in the case of the non-contiguous resource allocation as shown in (b) of FIG. 3, may be expressed by a conversion relation between them and the coefficients of the resource indicators of the resource allocation fields in the case of the non-contiguous resource allocation as shown in (c) of FIG. 3.

For example, the coefficients of start points and end points of the two non-contiguous clusters, which express the resource indicator of the resource allocation field in the case of the non-contiguous resource allocation as shown in (a) of FIG. 3, may have relations established by x(START₁)=y, y(END₁)=y+w, w(START₂)=y+w+z+1, and z(END₂)=x+y−1, respectively. In contrast, a relation between both sides may be expressed by x=END₂−START₁+1, y=START₁, z=START₂−END₁−1, and w=END₂−START₁. Herein, each variable has a range from “0” to (n−1).

For another example, the four offset values expressing the resource indicator of the resource allocation field in the case of the non-contiguous resource allocation as shown in (b) of FIG. 3 may have relations established by x(offset1)=y, y(offset2)=w, w(offset3)=z, and z(offset4)=x-w-z, respectively.

Referring to (d) in FIG. 3, a resource allocation field in the case of the non-contiguous resource allocation may include a resource indicator RIV indicating an offset y of resource block groups within the entire region 360 including the two clusters 310 and 320 and the region 330 of resource block groups which are not allocated as resources, a length x of the entire region 360, and a start point w and an end point z of the region 330 of resource block groups between the two clusters 310 and 320, which are not allocated as resources. At this time, the start point w and the end point z of the region of resource block groups between the two clusters, which are not allocated as resources, may be set with a start point 370 of all the resource block groups as reference.

Referring to (e) in FIG. 3, a resource allocation field in the case of the non-contiguous resource allocation may include a resource indicator RIV indicating an offset y of resource block groups within the entire region 360 including the two clusters 310 and 320 and the region 330 of resource block groups which are not allocated as resources, a length x of the entire region 360, and a start point w and an end point z of the region 330 of resource block groups between the two clusters 310 and 320, which are not allocated as resources. At this time, the start point w and the end point z of the region 330 of resource block groups between the two clusters 310 and 320, which are not allocated as resources, may be set with a start point 380 of resource block groups of the first cluster as reference.

As described above, a substitution relation is established between the coefficients for expressing the resource indicators of the resource allocation fields in the case of the non-contiguous resource allocation, which have been described with reference to (a) to (e) in FIG. 3.

Hereinabove, the resource indicator in the method for allocating resources of the two non-contiguous clusters has been described. Next, a resource indicator in a method for allocating resources of three non-contiguous clusters will be described.

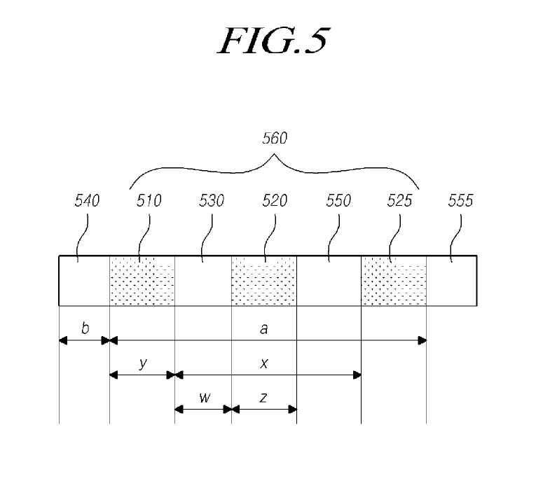

FIG. 5 is a view illustrating coefficients for expressing the allocation of non-contiguous resources having three clusters used for a method for allocating non-contiguous resources according to still another embodiment of the present invention. As shown in FIG. 5, instead of separately showing resource block groups as in FIG. 2, the resource block groups are expressed in such a manner as to divide all the resource block groups into regions 510, 520 and 525 of resource block groups allocated as resources and regions 530, 540, 550 and 555 of resource block groups which are not allocated as resources. The regions 510, 520 and 525 of resource block groups allocated as resources signify the clusters as described above. Referring to FIG. 5, in a resource allocation field in the case of the non-contiguous resource allocation, it is possible to construct a resource indicator RIV from an offset b of resource block groups within an entire region 560 including three clusters 510, 520 and 525 and regions 530 and 550 of resource block groups between the three clusters 510, 520 and 525, which are not allocated as resources, from a length a of the entire region 560, and from x, y, z and w representing offsets and lengths of the regions 530 and 550 of resource block groups within the entire region 560, which are not allocated as resources.

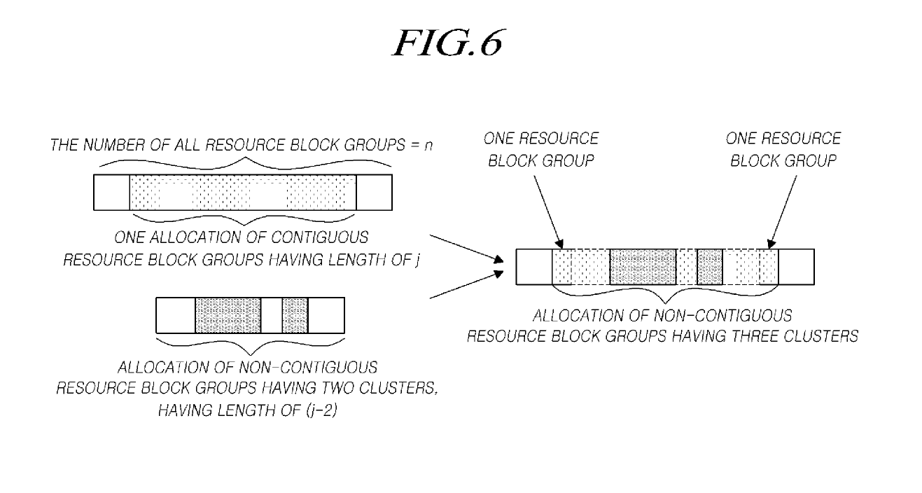

FIG. 6 is a view showing a concept expressing three clusters shown in FIG. 5 by using six coefficients. In this regard, for the clearness of the drawings, reference numerals used in FIG. 5 will not be shown in FIG. 6. Referring to FIG. 6, the two clusters included in the entire region 560 represent two regions of resource block groups between the three clusters, which are not allocated as resources, respectively.

At this time, contiguous resource block groups which have a length of j are expressed by an offset b and a length a of contiguous resource block groups, similarly to the resource indication value RIV of the resource allocation field in the case of the contiguous resource allocation described with reference to the upper part of FIG. 2. In order to express the three clusters, a region of resource block groups which are not allocated as resources exists in the form of two clusters within a resource allocation region, and the three clusters may be expressed by the value of RIV representing the two clusters. At this time, y representing an entire offset of the regions of resource block groups within the resource allocation region, which are not allocated as resources is given a value by indexing a resource block group having an offset of (b+1) as “0.”

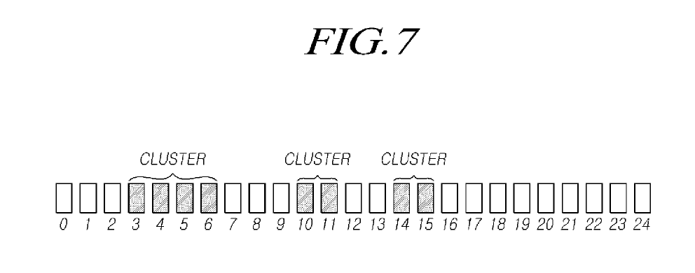

FIG. 7 is a view showing an example of a method for allocating non-contiguous resources according to still another embodiment of the present invention.

FIG. 7 shows a case where b=3, a=13, y=3, x=7, w=2 and z=2 when the number of all resource block groups is 25. The base station 20 may allocate four resource block groups among all the resource block groups to the particular user equipment 10, as described with reference to the lower part of FIG. 2, and may allocate resources of three non-contiguous clusters. As a result, the number of allocated resource block groups as shown in FIG. 7 is the same as that as shown the lower part of FIG. 2 (namely, 8 resource block groups among a total of 25 resource block groups). However, the method as shown in FIG. 7 can have an advantage in terms of resource allocation.

When it is assumed that values are given in the order of a (a=5, . . . , n), b (b=0, . . . , n-a), x (x=3, . . . , a−2), y (y=0, . . . , a−2−x), z (z=1, . . . , x−2), and w (w=0, . . . , x-z−2) for resource allocation, a resource indicator RIV of a resource allocation field in the case of allocating non-contiguous resources in the scheme as shown in FIG. 7, may be expressed by equation (4) below. Namely, when the number of all resource block groups is n, if values are given in the order of the length a of the entire region including the three clusters and the regions of resource block groups between the three clusters resource, which are not allocated as resources, the offset b of resource block groups within the entire region, and x, y, z and w representing the offsets and the lengths of the regions of resource block groups within the entire region, which are not allocated as resources, a resource indicator RIV may be expressed by equation (4) below.

RIV(3)=RIV₁(a,n)+RIV₂(a,b)+RIV₃(x,a−2)+RIV₄(x,y)

+RIV₅(x,z)+RIV₆(w), and

RIV=0, . . . ,ₙ₋₁C₆−1 (4)

In equation (4), RIV₁(a, n) corresponding to a function of a and n is the number of resource allocations, up to (a−1). RIV₂(a, b) corresponding to a function of a and b is the number of resource allocations according to a change in the value of b. RIV₃(x, a−2) corresponding to a function of x and (a−2) is the number of resource allocations, up to (x−1). RIV₄(x, y) corresponding to a function of x and y is the number of resource allocations according to a change in the value of y. RIV₅(x, z) corresponding to a function of x and z is the number of resource allocations, up to (z−1). RIV₆(w) corresponding to a function of w is the number of resource allocations according to a change in the value of w.

RIV₁(a, n), RIV₂(a, b), RIV₃(x, a−2), RIV₄(x, y), RIV₅(x, z) and RIV₆(w) are expressed by using n corresponding to the number of all the resource block groups and the six coefficients a, b, x, y, w and z, as described above, by equation (5) below.

$${RIV}_{1} ( a , n ) = \frac{2 ( n + 11 ) a ( a + 1 ) ( 2 a - 1 ) ( 3 {( a - 1 )}^{2} + 3 ( a - 1 ) - 1 )}{24 \cdot 60} \frac{+ 10 ( 35 n + 85 ) a ( a - 1 ) ( 2 a - 1 ) + 24 \cdot 60 ( n + 1 ) ( a - 1 )}{ } - \frac{\begin{matrix}5 {{a}^{2} ( a + 1 )}^{2} ( 2 {( a - 1 )}^{2} + 2 ( a - 1 ) - 1 ) + \\ 15 ( 10 n + 45 ) {{a}^{2} ( a - 1 )}^{2}\end{matrix}}{24 \cdot 60} \frac{+ 24 \cdot 30 ( 50 n + 74 ) a ( a - 1 )}{ } , a = 5 , … , n \\ {RIV}_{2} ( a , b ) = \frac{( x - 4 ) ( x - 3 ) ( x - 2 ) ( x - 1 ) b}{24} , b = 0 , … , n - a \\ {RIV}_{3} ( x , a - 2 ) = \frac{( x - 1 )}{ } \frac{\cdot ( \begin{matrix}( 4 ( a - 2 ) + 19 ) {x}^{2} + \\ 24 ( ( a - 2 ) + 1 ) - 3 {x}^{3} - ( 20 ( a - 2 ) - 38 ) x\end{matrix} )}{24} , \\ x = 3 , … , a - 2 \\ {RIV}_{4} ( x , y ) = \frac{( x - 2 ) ( x - 1 ) y}{2} , y = 0 , … , a - 2 - x \\ {RIV}_{5} ( x , z ) = ( x - 1 ) ( z - 1 ) - \frac{z ( z - 1 )}{2} , z = 1 , … , x - 2 and \\ {RIV}_{6} ( w ) = w , w = 0 , … , x - z - 2 \qquad ( 5 )$$

Hereinabove, both the resource indicator in the method for allocating resources of two non-contiguous clusters and the resource indicator in the method for allocating resources of three non-contiguous clusters have been described. Next, a resource indicator in a method for allocating resources of a k number of non-contiguous clusters, to which the above two methods are generalized, will be described.

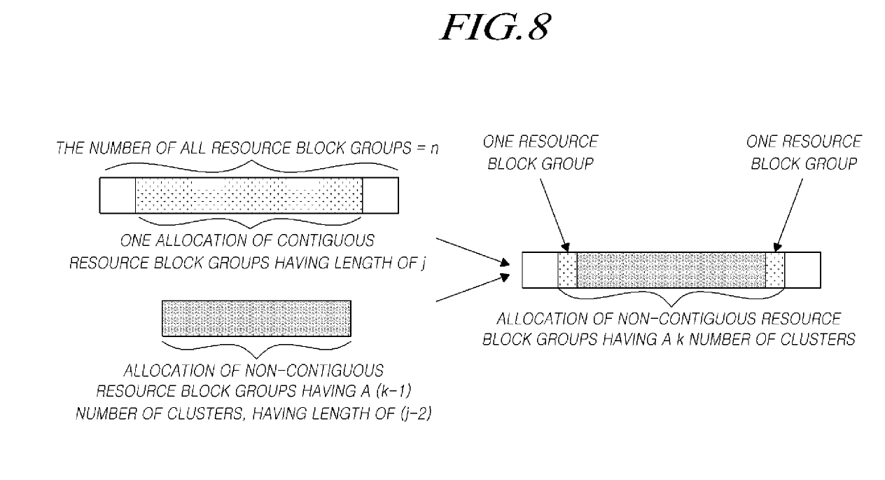

FIG. 8 is a view showing a concept expressing a k number of clusters by using a 2k number of coefficients. The allocation of resource block groups of a k number of typical clusters can be shown as in FIG. 8. Namely, an RIV value expressing a k number of non-contiguous clusters may include two coefficients (i.e. offset and length) representing an entire region, and coefficients (i.e. offsets and lengths) of a (k−1) number of non-contiguous regions of resource block groups within the entire region, which are not allocated as resources. In other words, when the number of all resource block groups is n, the allocation of non-contiguous resource block groups having a k number of clusters may be expressed by using one allocation of contiguous resource block groups which have a length of j and the allocation of non-contiguous resource block groups having a (k−1) number of clusters, which have an overall length of (j−2). In this case, it goes without saying that the range of j is up to n corresponding to the number of all the resource block groups.

A (k−1) number of non-contiguous regions of resource block groups, which are not allocated as resources may be expressed by using an RIV value representing a (k−1) number of clusters, and an RIV value for a k number of clusters may be recursively constructed. In this recursive construction, for a (k−1) number of non-contiguous regions of resource block groups within the entire region, which are not allocated as resources, an RIV value is designated in a range where a value is less by 2 than the length representing the entire region. Accordingly, a start point of each offset and the range of the length thereof are determined. As well as configuring of non-contiguous resources as described above and the scheme as shown in FIG. 3, it is possible to construct various RIVs in the non-contiguous resource allocation. When the resource configuration is expressed by the schemes as described above and other general schemes, namely, the resource allocation is expressed by coefficients x₁, x₂, . . . , xₖ (being expressed by a k number of coefficients), in this specification, a method for expressing a resource indicator (RIV(x₁, x₂, . . . , xₖ, n)) of a generalized resource allocation field is defined by equation (6) below.

RIV(x₁,x₂, . . . ,xₖ,n)=RIV₁(x₁,n)+RIV₂(x₁,x₂,n)+ . . .+RIVₖ(x₁,x₂, . . . ,xₖ,n) (6)

In equation (6), x₁, x₂, . . . , and xₖ signify at least one of an offset, the length of resource block groups, and a start point or an end point of a particular cluster, and n signifies the number of all the resource block groups. Also, RIV₁(x₁, n) corresponding to a function of x₁ and n is a number representing each of all combinations (under the condition of x₁=x₁^{fixed) in a possible range of each of coefficients of x}₂, . . . , xₖ when the value of x₁ is fixed to x₁=x₁^{fixed}. RIV₂(x₁, x₂, n) corresponding to a function of x₁, x₂ and n is a number representing each of all combinations (under the condition of x₁=x₁^{fixed} and x₂=x₂^{fixed}) in a possible range of each of coefficients of x₃, . . . , xₖ when values of x₁ and x₂ are fixed to x₁=x₁^{fixed} and x₂=x₂^{fixed}. When this resource indicator is expressed in a generalized manner, RIV(x₁, x₂, . . . , xₖ, n) corresponding to a function of x₁, x₂, . . . , xₖ, and n is a number representing each of all combinations (under the condition of x₁=x₁^{fixed}, x₂=x₂^{fixed}, . . . , and xᵢ=xᵢ^{fixed}) in a possible range of each of coefficients of xᵢ₊₁, . . . , xₖ when values of x₁, x₂, . . . , and xᵢ are fixed to x₁=x₁^{fixed}, x₂=x₂^{fixed}, . . . , and xᵢ=xᵢ^{fixed}. Herein, in order to cause the value of RIV(x₁, x₂, . . . , xₖ, n) 0 to start from 0, x=x^{fixed}−1 may be adopted instead of xᵢ=xᵢ^{fixed}.

When the resource indicator RIV(x₁, x₂, . . . , xₖ, n) of the resource allocation field is expressed as described above, the transmission of a message including an information field (e.g. resource allocation field), for example, including of a resource allocation field in a PDCCH DCI format 0 and transmitting of the PDCCH DCI format 0 including the resource allocation field to the user equipment 10, and receiving and decoding of this message by the user equipment 10 may be expressed as follows:

1) i is assigned a value of “1.” (The indexing of i may start from “0.” Namely, the value of i may start from “0.”)

2) xᵢ=xᵢ^{dec} which satisfies a condition of RIVᵢ(x₁^{dec}, x₂^{dec}, . . . , xᵢ₋₁^{dec}, xᵢ, . . . , xₖ, n)≦RIV_{rcv} and causes RIVᵢ(x₁^{dec}, x₂^{dec}, . . . , xᵢ₋₁^{dec}, xᵢ, . . . , xₖ, n) to be closest to RIV_{rcv}, is calculated by using the received RIV_{rcv} value.

3) RIV_{rcv}=RIV_{rcv}−xᵢ^{dec}.

4) i=i+1

5) If i>k, then end; else return to step 2).

For example, the four offsets express the resource indicator for the two non-contiguous clusters as shown in (b) of FIG. 3. However, by generalizing the scheme as shown in (b) of FIG. 3, a 2k number of offsets may express a resource indicator for a k number of non-contiguous clusters. In this case, two pairs among a 2k number of offsets may express a start point and an end point of a particular cluster, respectively.

In the other schemes as shown FIG. 3, equation (6) may similarly express a resource indicator for a k number of non-contiguous clusters.

Hereinabove, the resource indicator in the method for allocating resources of a k number of non-contiguous clusters has been described. Next, a common resource indicator in a method for allocating contiguous and non-contiguous resources will be described.

As described above, the method for constructing the resource indicator of the resource allocation field in the case of the contiguous resource allocation has been described with reference to the upper part of FIG. 2. Also, the method for constructing the resource indicator of the resource allocation field in the case of the non-contiguous resource allocation has been described with reference to the lower part of FIG. 2 to FIG. 7. Herein, different number assignment systems may be used to assign resource allocation indications to resource indicators of a resource allocation field in the case of allocating contiguous and non-contiguous resources, respectively. However, one number assignment system may be used to assign resource allocation indications.

For example, when numbers are assigned in allocating resources of a k number of clusters, assigning of a number to a resource indicator of a resource allocation field is as follows.

RIV(k) is defined as a resource indicator RIV of a resource allocation field having a k number of clusters. At this time, it is assumed that RIV(k) has a form in which RIV(k) starts from “0.”

$${RIV}_{total} = {\sum }_{i = 1}^{k - 1} ( {RIV}^{ma x} ( i ) + 1 ) + RIV ( k ) \qquad ( 7 )$$

In equation (7), RIV^{max}(i) represents a maximum value of an RIV value of a resource allocation field having an i number of clusters.

Assigning of a number to the above resource indicator of the resource allocation field has a scheme in which the value of a number to be assigned increases while an RIV having a smaller number of clusters is arranged from “0” one by one.

When it is assumed that RIV(k) has a form in which RIV(k) starts from “0,” it may be expressed by equation (8) below.

$${RIV}_{total} ( k ) = {\sum }_{i = 1}^{k - 1} {RIV}^{ma x} ( i ) + RIV ( k ) \qquad ( 8 )$$

Hereinafter, when contiguous resources are allocated and resources of two non-contiguous clusters are allocated, an example of assigning a number to a resource indicator of a resource allocation field by using one number assignment system will be described.

As described above, the resource indicator of the resource allocation field in the case of the contiguous resource allocation may be expressed by equation (1). Also, the resource indicator of the resource allocation field in the case of allocating resources of two non-contiguous clusters may be expressed by equations (2) and (3).

At this time, when resource indicators of a resource allocation field in the case of allocating contiguous and non-contiguous resources are applied to equation (8), a result of the application may be expressed as one number assignment system by equation (9) below.

$${RIV}_{total} ( 2 ) = \{ \begin{matrix}{RIV}_{LTE} ( z , w , n ) & ( contiguous ) \\ RIV ( 2 ) + \frac{n ( n + 1 )}{2} & ( non \text{-} contiguous )\end{matrix} \\ or \\ {RIV}_{total} ( 2 ) = \{ \begin{matrix}{RIV}_{LTE} ( z , w , {n}^{′} ) & ( contiguous ) \\ RIV ( 2 ) + \frac{{n}^{′} ( {n}^{′} + 1 )}{2} & ( non \text{-} contiguous )\end{matrix} \qquad ( 9 )$$

In equation (9), z is expressed as z=L_{CRBs} and w is expressed as w=RBₛₜₐᵣₜ. Also, n′ is expressed as n′=N_{RB}^{DL} or N_{RB}^{UL}, and n is expressed as n=N_{RBG}^{DL} or N_{RBG}^{UL}. Namely, these equations imply that a resource block or a resource block group may be established as a unit. Namely, the second equation implies that resources are allocated on a per-resource block basis in the case of contiguous resource allocation whereas resources are allocated on a per-resource block group basis in the case of non-contiguous resource allocation. Also, the other coefficients in equation (9) are expressed as described in equations (1) to (3).

In equation (9), a resource indicator RIV_{LTE}(z, w, n) of the resource allocation field in the case of the contiguous resource allocation ranges from 0 to (n(n+1)/2−1). Also, a resource indicator RIV(2) of the resource allocation field in the case of the non-contiguous resource allocation is assigned a number from n(n+1)/2. Therefore, both resource indicators may be expressed by using one number assignment system.

When contiguous resources are allocated in this scheme for number assignment, there is an advantage in that bit allocation is not required to discriminate between clusters simultaneously with maintaining backward compatibility with the resource indicator of the resource allocation field.

In the scheme for assigning, respectively, different numbers to the resource indicators of the resource allocation field in the case of allocating contiguous and non-contiguous resources, the assignment of one or more additional bits is required to discriminate between clusters. In contrast, as described above, in the scheme for assigning numbers, by using one number assignment system, to the resource indicators of the resource allocation field in the case of allocating contiguous and non-contiguous resources, it may not be required to assign additional bits as described above.

In equation (8), RIV(k) may be obtained not only by an identical number assignment system, but also by another number assignment system (namely, not a number system obtained by the accumulation system proposed in the present invention, but a number system which may be constructed by another general number assignment system). Also, k values may overlap, or a value less than the value of an original k, which is obtained from another number system, may first be inserted and then an addition formula may be obtained. The value of i may start not from “1” but from a value equal to or greater than “1.”

Hereinabove, the common resource indicator in the method for allocating contiguous and non-contiguous resources has been described. Next, a partial replacement of a resource indicator of a resource allocation field will be described.

As described above of the resource indicator RIV in the method for allocating resources of two non-contiguous clusters and the resource indicator RIV in the method for allocating resources of three non-contiguous clusters, in the case of constructing a resource indicator of a resource allocation field in the case of allocating non-contiguous resources of two or more clusters, a resource indicator for contiguous resource allocation in the existing 3GPP LTE is used for a partial configuration of the resource indicator. Accordingly, an advantage can be obtained in that the complexity of decoding on a receiver side is reduced. As described above of the resource indicator RIV in the method for allocating resources of two non-contiguous clusters and the resource indicator RIV in the method for allocating resources of three non-contiguous clusters, in this specification, a resource indicator is constructed by using a number system representing allocations of resources of non-contiguous clusters based on contiguous resource allocation. However, actual number assignment may have a different form from that of a resource indicator for contiguous resource allocation in the existing 3GPP LTE.

In other words, in equation (6) expressing a resource indicator, an application may be configured in such a manner that some calculated values of one or more of RIV₁ to RIVₖ are replaced by a resource indication value RIV in the case of contiguous resource allocation, which indicates a start point of a resource block group (namely, a starting resource block RBₛₜₐᵣₜ) and is the length of contiguous virtual resource blocks (namely, a length L_{CRBs} in terms of virtually contiguously-allocated resource blocks).

When the number of non-contiguous clusters is 2 and the number of non-contiguous clusters is 3, an example where a resource indicator of a resource allocation field in the case of contiguous resource allocation is applied to some calculated values of each of RIV(2) and RIV(3) will be described below.

In RIV(2), z=1, . . . , x−2, and w=0, . . . , x-z−2, and thus RIV₃(x, z)+RIV₄(w)→RIV_{LTE}(x−2, z, w). Herein, z=1, . . . , x−2, and w=O, . . . , x-z−2.

In RIV(3), RIV₅(x, z)+RIV₆(w)→RIV_{LTE}(x−2, z, w). Herein, z=1, . . . , x−2, and w=0, . . . , x-z−2.

This method makes it possible to obtain an advantage in the complexity of decoding simultaneously with improving backward compatibility.

As described above, an uplink scheduling grant or a PUSCH grant may use a DCI format 0 among PDCCH DCI formats corresponding to a control channel. However, in order to support a method for allocating resources, a channel other than a control channel, for example, a data channel may be used for an uplink scheduling grant or a PUSCH grant. Otherwise, even when the control channel is used, a control channel other than a PDCCH may be used. Otherwise, even when the PDCCH is used, use may be made of a format other than the DCI format 0, or a newly-defined format, or a DCI format for downlink.

Hereinafter, assigning of an uplink scheduling grant or a PUSCH grant by using the PDCCH DCI format 0 will be described. However, the present invention is not limited to this configuration.

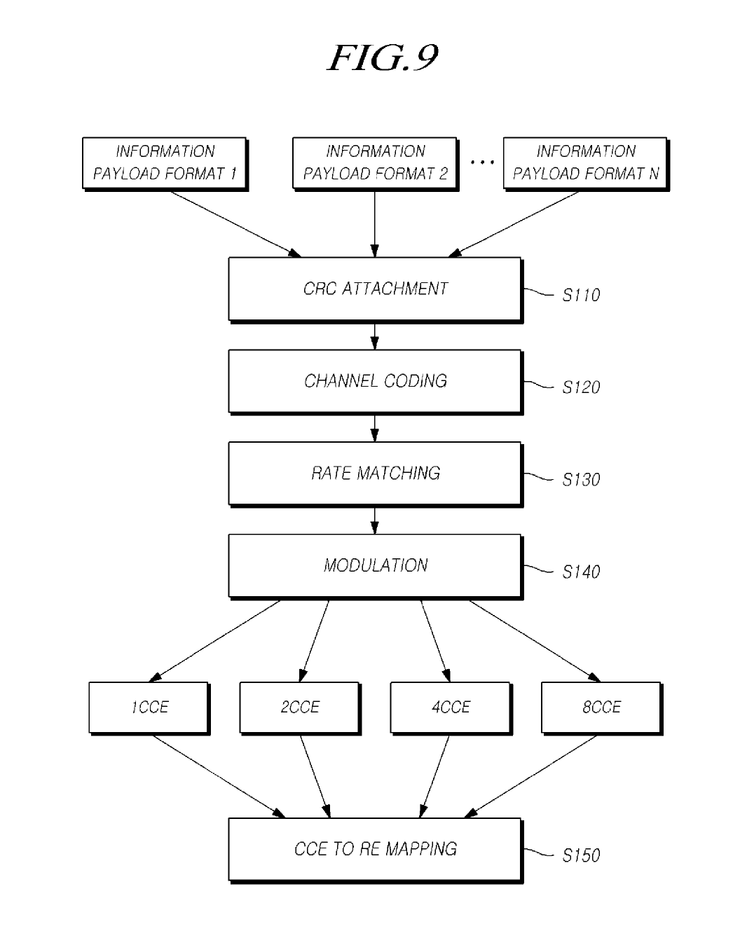

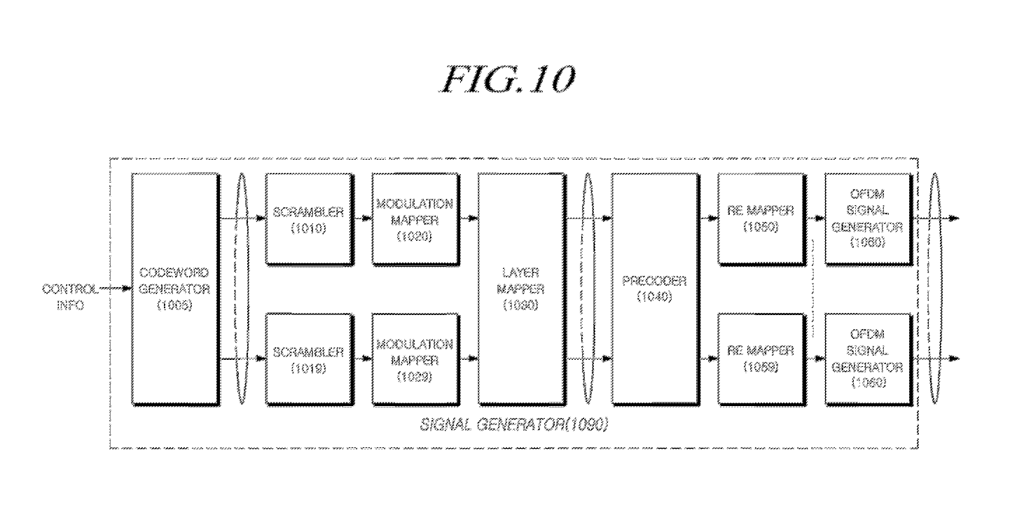

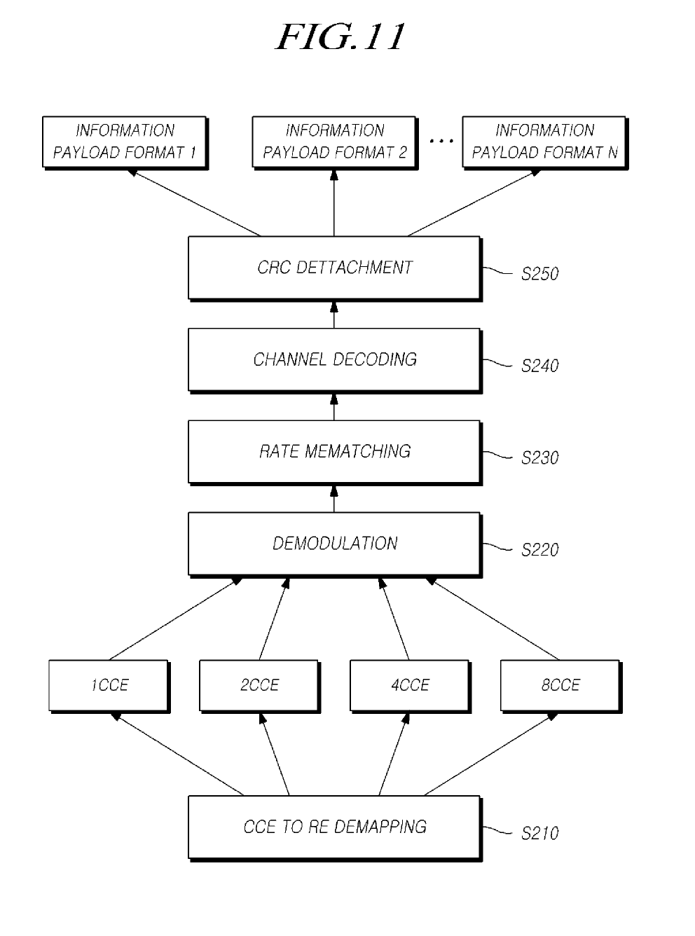

FIG. 9 is a flowchart showing a method for configuring a PDCCH according to still another embodiment of the present invention. FIG. 10 is a block diagram showing the configuration of a base station according to still another embodiment of the present invention, which generates control information in downlink. FIG. 11 is a flowchart showing a method for processing a PDCCH according to still another embodiment of the present invention.

Referring to FIG. 1 and FIG. 9, the base station 20 configures a PDCCH payload according to an information payload format to be transmitted to the user equipment. The PDCCH payload may have various lengths according to the information payload format. The information payload format may be a DCI format.

As described above, the DCI format 0 is configured by expressing a resource indicator RIV within a resource allocation field in the DCI format 0. At this time, the resource allocation field may include a resource indicator RIV expressed in a scheme described with reference to each of FIGS. 2 to 8. However, a detailed description thereof will be omitted in order to avoid repetition. For example, the resource indicator may be expressed by RIV(x₁, x₂, . . . , xₖ, n)=RIV₁(x₁, n)+RIV₂(x₁, x₂, n)+ . . . +RIVₖ(x₁, x₂, . . . , xₖ, n) in equation (6) as described above (herein, x₁, x₂, . . . , and xₖ signify at least one of an offset, the length of resource block groups, and a start point or an end point of a particular cluster, and n signifies the number of all the resource block groups).

At this time, it goes without saying that another information payload format may exist as a DCI format.

In step S110, a Cyclic Redundancy Check (CRC) for error detection is added to each PDCCH payload. The CRC is masked with an identifier named RNTI (Radio Network Temporary Identifier) in accordance with the owner or usage of the PDCCH.

In step S120, control information to which the CRC is added, is channel-coded and coded data is generated.

In step S130, a rate matching according to a Control Channel Element (CCE) aggregation level allocated to the PDCCH format is performed.

In step S140, the coded data is modulated and modulation symbols are generated.

In step S150, the modulation symbols are mapped to physical Resource Elements (CCE-to-RE mapping).

The generalization of the method for configuring control information as described with reference to FIG. 9 to a method for transmitting control information is as follows. The base station may perform adding a CRC for error detection to control information including the resource allocation information expressed by RIV(x₁, x₂, . . . , xₖ, n)=RIV₁(x₁, n)+RIV₂(x₁, x₂, n)+ . . . +RIVₖ(x₁, x₂, . . . , xₖ, n) in equation (6), generating coded data by channel-coding the control information to which the CRC is added, generating modulation symbols by modulating the coded data, and mapping the modulation symbols to physical resource elements. Then, the base station may transmit the control information to the user equipment.

FIG. 10 is a block diagram showing the configuration of a base station according to still another embodiment of the present invention, which generates control information in downlink.

Referring to FIG. 1 and FIG. 10, in a signal generator 1090, a codeword generator 1005, scramblers 1010, . . . , and 1019, modulation mappers 1020, . . . , and 1029, a layer mapper 1030, a precoder 1040, resource element mappers 1050, . . . , and 1059, and an OFDM signal generators 1060, . . . , and 1069 may exist as separate elements. Otherwise, two or more elements may be combined, and the combined elements may operate as one element.

The control information obtained by adding the CRC to the control information including the resource allocation information expressed by RIV(x₁, x₂, . . . , xₖ, n)=RIV₁(x₁, n)+RIV₂(x₁, x₂, n)+ . . . +RIVₖ(x₁, x₂, . . . , xₖ, n) in equation (6) as described above, is input to the signal generator 1090.

The control information to which the CRC is added, is generated as an OFDM signal by the codeword generator 1005, the scramblers 1010, . . . , and 1019, the modulation mappers 1020, . . . , and 1029, the layer mapper 1030, the precoder 1040, the resource element mappers 1050, . . . , and 1059, and the OFDM signal generators 1060, . . . , and 1069. Then, the generated OFDM signal is transmitted to the user equipment via an antenna.

In the process of generating an OFDM signal as shown in FIG. 10, precoding in the process of generating a PDCCH which is an embodiment described with reference to FIG. 9 is omitted, and thus the input and output of precoding may be identical. Also, after the generation of a codeword, a signal may not go through multiple paths. TCC (Tailbiting Convolutional Coding) may be used to generate a PDCCH, and an operation related to RM (Rate Matching) may be applied to the generation of a PDCCH.

FIG. 11 is a flowchart showing a method for processing a PDCCH.

Referring to FIG. 1 and FIG. 11, in step S210, the user equipment 10 demaps a physical Resource Element (RE) to a CCE (RE-to-CCE demapping).

In step S220, because the UE 10 does not know a CCE aggregation level at which the user equipment 10 should receive a PDCCH, the user equipment 10 performs demodulation at a CCE aggregation level, which a payload corresponding to a reference DCI format according to a transmission mode of the user equipment 10 may have.

In step S230, the user equipment 10 performs rate dematching on the demodulated data according to the relevant payload and the CCE aggregation level.

In step S240, the user equipment 10 channel-decodes the coded data according to a coding rate, and detects whether an error has occurred, by performing a CRC check on the channel-decoded coded data. If no error has occurred, it implies that the user equipment 10 has detected its own PDCCH. If an error has occurred, the user equipment 10 continuously performs blind decoding with respect to another CCE aggregation level or another DCI format.

In step S250, the user equipment 10 that has detected its own PDCCH removes the CRC from the decoded data, and acquires control information necessary for the user equipment 10.

Particularly, the user equipment 10 detects a DCI format 0, and interprets an uplink scheduling grant included in this DCI format 0. At this time, detecting of the DCI format 0 and interpreting of the uplink scheduling grant included in this DCI format 0 may be performed by first calculating an RIV through a decoding process and then calculating coefficients of the corresponding resource indicator, when the resource indicator RIV(x₁, x₂, . . . , xₖ, n) of the resource allocation field is expressed as described above.

Other DCI formats are detected. Then, by using downlink scheduling assignment information, uplink scheduling grant information, and power control command information included in this control information, it is possible to perform functions of downlink scheduling assignment, an uplink scheduling grant, and power control of a relevant component carrier identified by a component carrier indicator.

The generalization of the method for processing control information, which has been described with reference to FIG. 11, will be described below.

The user equipment performs: demapping physical resource elements, through which the user equipment has received control information from the base station, to symbols (RE-to-CCE demapping); demodulating demapped symbols and generating data; channel-decoding the demodulated data, and detecting whether an error has occurred, by performing a CRC check on the channel-decoded demodulated data; acquiring necessary control information by removing the CRC from the decoded data; and interpreting resource allocation information expressed by RIV(x₁, x₂, . . . , xₖ, n) from the acquired control information. By doing this, the user equipment may process the control information.

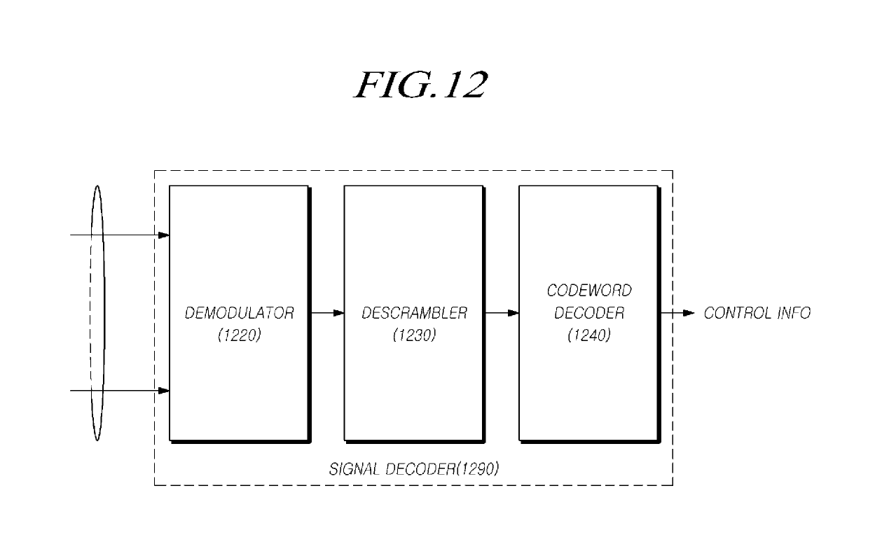

FIG. 12 is a block diagram showing the configuration of a user equipment according to still another embodiment of the present invention.

Referring to FIG. 1 and FIG. 12, the user equipment receives a signal from the base station via an antenna.

A demodulator 1220 provides a function of demodulating the received signal. When the base station transmits an OFDM signal, the user equipment demodulates the received signal in the OFDM scheme. Otherwise, according to whether a signal is generated by the base station in an FDD scheme or in a TDD scheme, the user equipment may demodulate the received signal in the relevant scheme.

A demodulated signal is first descrambled by a descrambler 1230, and then a codeword having a predetermined length is generated. A codeword decoder 1240 again reconstructs predetermined control information from the generated codeword. This function may be performed at one time by a signal decoder 1290. Otherwise, this function may be performed independently or sequentially by two or more elements.

Finally, resource allocation information expressed by RIV(x₁, x₂, . . . , xₖ, n) is interpreted from this reconstructed control information by an upper layer higher than a physical layer which reconstructs a signal.

Hereinabove, the description has been made of the method and the apparatus for assigning an uplink scheduling grant or a PUSCH grant by using the PDCCH DCI format 0, and the method and the apparatus for reconstructing resource allocation information, when non-contiguous resources are allocated. Hereinafter, a description will be made of transmitting of information on non-contiguous resource allocation in the form and size of control information identical to those of control information in the case of transmitting information on contiguous resource allocation.

As described above, although not limited to this configuration, in the case of resource allocation in uplink, control information is transmitted by using an uplink grant, and the uplink grant may correspond to the DCI format 0. At this time, when the number of clusters becomes larger in the case of non-contiguous resource allocation, resource allocation information for expressing the clusters, the number of which becomes larger, namely, the range of an RIV becomes larger. Accordingly, the required number of bits may become larger, and overhead may increase. At this time, the number of clusters in the case of non-contiguous resource allocation may be 2 to 4. As described above, an increase in the number of clusters increases overhead. However, an increase in the number of non-contiguous clusters may bring about an improvement in throughput.

The method for allocating resources of two non-contiguous clusters has been described with reference to FIG. 2 and FIG. 3, and a resource indicator has been expressed by each of equation (2) and equation (3). Also, the method for allocating resources of three non-contiguous clusters has been described with reference to FIG. 6 and FIG. 7, and a resource indicator has been expressed by each of equation (4) and equation (5).

The method for allocating non-contiguous resources, which expresses a k number of clusters by combining allocating of a j number of resource regions among a total of n resource block groups and allocating of a (k−1) number of clusters in the overall range of (j−2), has been described with reference to FIG. 8. Also, the resource indicator of the generalized resource allocation field in this method has been expressed by equation (6).

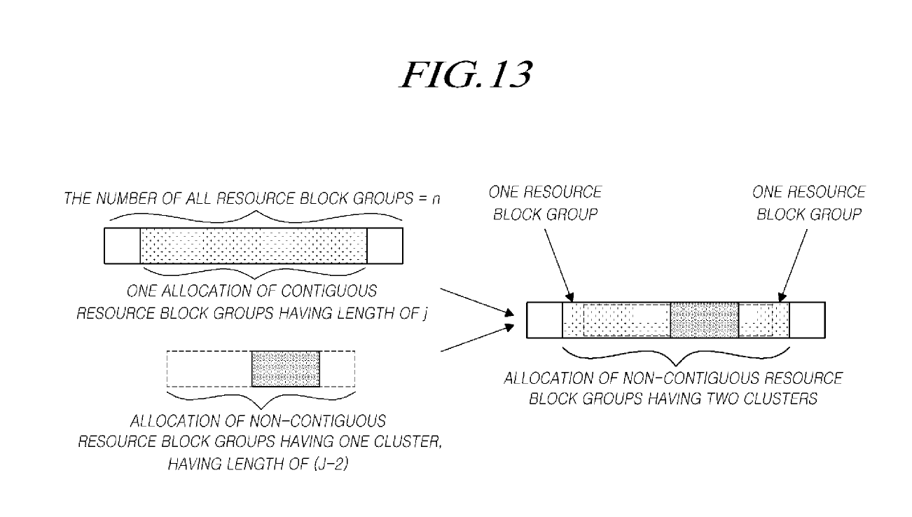

FIG. 13 is substantially identical to FIG. 8 except for the limitation of the range of j. Hereinafter, a method for allocating non-contiguous resources, which does not exceed the size of an uplink grant together with maintaining an advantage of an improvement in throughput according to the non-contiguous resource allocation, will be described below with reference to FIG. 13.

Referring to FIG. 13, j may have a value from (2k−1) to n, and may also have a value ranging from (2k−1) to m. Namely, the range of m is expressed by (2k−1)=m<n. As a result, in FIG. 13, the range of j is expressed by (2k−1)=j=m (i.e. (2k−1)=m<n). Accordingly, clusters shown in FIG. 13 may have different sizes, and may be non-uniform within a range determined by m. Herein, a maximum range region which may be set by the start of a first cluster and the end of a last cluster corresponds to m. This maximum range region may have a maximum range of m, and simultaneously, may exist anywhere between 1 to n within a region of all resource block groups.

In the case of the method for allocating resources of two non-contiguous clusters, which has been described with reference to FIG. 2 and FIG. 3 (when the number of clusters is 2), the value of j is x, and thus j may have a range of 3=x=m (3=m<n). In the case of the method for allocating resources of three non-contiguous clusters, which has been described with reference to FIG. 6 and FIG. 7 (when the number of clusters is 3) the value of j is a. Accordingly, this implies that j may have a range of 5=a=m (5=m<n). At this time, the method for allocating resources of two non-contiguous clusters, which has been described with reference to FIG. 2 and FIG. 3 or the method for allocating resources of three non-contiguous clusters, which has been described with reference to FIG. 6 and FIG. 7 are the same as described above except for the range of x and the range of a. Accordingly, a detailed description thereof will be omitted in order to avoid repetition.

Hereinabove, the description has been made of transmitting of information on non-contiguous resource allocation in the form and size of control information identical to those of control information in the case of transmitting information on contiguous resource allocation. Hereinafter, a description will be made of a process of determining the value of m according to the required number of particular bits and the value of m determined by the process, when non-contiguous resources are allocated.

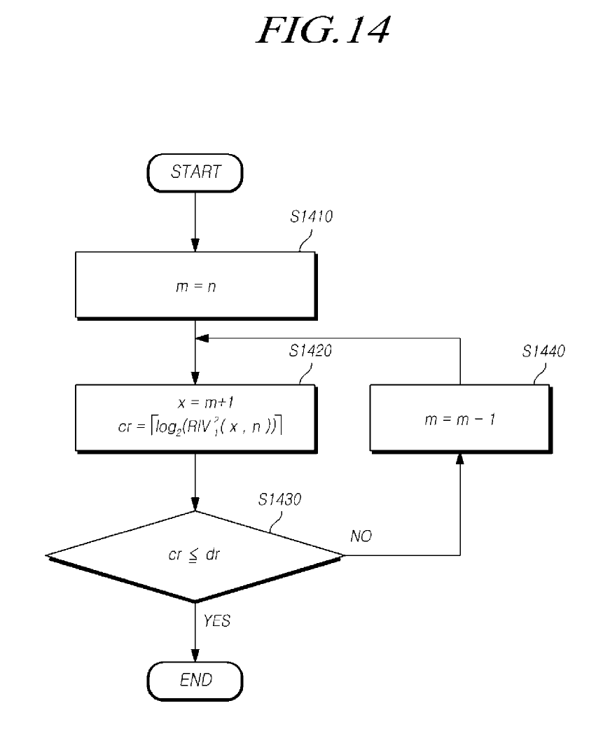

FIG. 14 is a flowchart showing a process of determining the value of m according to the required number of particular bits when resources of two non-contiguous clusters are allocated.

Referring to FIG. 14, first, the value of m is set to n (S1410).

Then, the number of bits of a binary number expressing the number of all cases of a range possessed by all clusters (namely, a range represented by a start point of a first cluster and an end point of a last cluster) is calculated (S1420). Because RIV₁(x₁, n) represents the number of all cases up to (x−1) in equation (2) or equation (3), RIV₁(m+1, n) represents all cases of the range possessed by all the clusters (the range represented by the start point of the first cluster and the end point of the last cluster, the value of which is m) when x=m+1. At this time, in order to express that RIV₁(x₁, n) is related to two clusters, the superscript “2” such as RIV₁²(x, n) is used in equation (10) below. As a result, a reduction in the required number of bits, which results from the value of m, may be obtained by performing the calculation of equation (10) below. In equation (10) below, cr represents the required number of bits given by each x=m+1.

x=m+1 and

cr=┌log₂(RIV₁²(x,n))┐ (10)

Then, by comparing cr corresponding to the required number of bits given by each x=m+1 with dr which represents the required number of bits as a target, a determination is made as to whether cr is equal to or less than dr (S1430). When cr is not equal to or less than dr, namely, when cr is greater than dr, step S1420 and step S1430 are repeated for a value obtained by subtracting 1 from the value of m.

Meanwhile, when cr is equal to or less than dr, m has a value corresponding to the range of all clusters satisfying the required number of bits as a target.

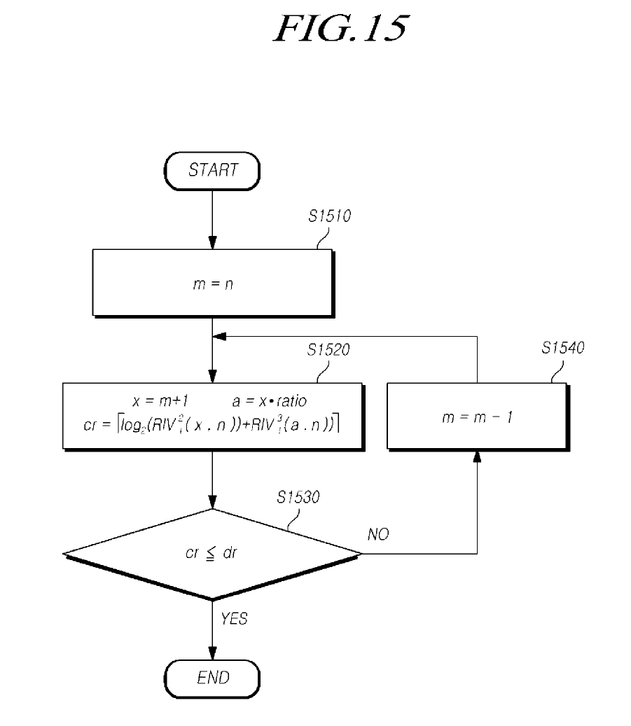

FIG. 15 is a flowchart showing a process of determining the value of m according to the required number of particular bits when resources of three non-contiguous clusters having such a form that two clusters are combined with three clusters are allocated.

Referring to FIG. 15, first, the value of m is set to n (S1510).

Then, the number of bits of a binary number expressing the number of all cases of a range possessed by all clusters (namely, a range represented by a start point of a first cluster and an end point of a last cluster) is calculated (S1520).

RIV₁²(x, n) represents all cases of a range possessed by all clusters with respect to two clusters, as described above. RIV₁³(a, n) represents all cases of a range possessed by all clusters with respect to three clusters (herein, the superscript “3” signifies the three clusters). Accordingly, the sum of RIV₁²(x, n) and RIV₁³(a, n) represents all cases of a range possessed by all clusters with respect to two clusters and three clusters. As a result, a reduction in the required number of bits, which results from the value of m may be obtained by performing the calculation of equation (11) below. In equation (11) below, cr represents the required number of bits given by each x=m+1.

x=m+1,a=x·ratio and

cr=┌log₂(RIV₁²(x,n)+RIV₁³(a,n))┐ (11)

In a=x·ratio as expressed in equation (11), ratio represents a relative ratio of an overall range possessed by two clusters to an overall range possessed by three clusters.

Then, by comparing cr corresponding to the required number of bits given by each x=m+1 with dr which represents the required number of bits as a target, a determination is made as to whether cr is equal to or less than dr (S1530). When cr is not equal to or less than dr, namely, when cr is greater than dr, step S1520 and step S1530 are repeated for a value obtained by subtracting 1 from the value of m.

Meanwhile, when cr is equal to or less than dr, m has a value corresponding to the range of all clusters satisfying the required number of bits as a target.

The value of m in the case where dr is set to have a value less by one bit than the number of resource allocation bits that an uplink grant has, is calculated as described in Table 1 below where ratio=1.

TABLE 1

| | The number of | The number of | The number of | | | |
|---|---|---|---|---|---|---|
| | resource | resource | bits of resource | m, dr = RA | m, dr = RA | m, dr = RA + 1 |
| Bandwidth | blocks | block groups | allocation field | (2 | ((2 + 3) | ((2 + 3) |
| (MHz) | (#ofRB) | (#ofRBG) | (RA map size) | clusters) | clusters) | clusters) |
| 1.4 | 6 | 6 | 5 | 5 | 5 | 6 |
| 3 | 15 | 8 | 7 | 8 | 6 | 8 |
| 5 | 25 | 13 | 9 | 8 | 7 | 8 |
| 10 | 50 | 17 | 11 | 12 | 8 | 10 |
| 15 | 75 | 19 | 12 | 16 | 9 | 11 |
| 20 | 100 | 25 | 13 | 16 | 10 | 12 |

In Table 1, RA signifies the number of bits of a resource allocation field in a DCI format 0 corresponding to an uplink grant. For example, when a bandwidth (BW) is 20 MHz, the number of resource blocks is 100, and the number of resource block groups is 25, the number of bits RA of a resource allocation field in a DCI format 0 corresponding to an uplink grant is 13 bits. At this time, when cr is equal to or less than dr, m has a value of 10. When use may be made of one bit more than RA, m has a value of 12. A case where use may be made of one bit more than RA signifies a case where FH (Frequency Hopping) bits are used as a resource allocation field in the conditions of non-contiguous resource allocation.

An example where the number of non-contiguous clusters is 2 or 3 has been described with reference to FIG. 14 and FIG. 15. However, even when the number of non-contiguous clusters is 4 or more, the value of m may be similarly determined. Namely, when the number of contiguous clusters is k, after the calculation of all cases of a range possessed by all clusters with respect to clusters, the number of which is 2 to k, the value of a binary number expressing the calculated value determines the value of m which is equal to or less than the number of bits RA of a resource allocation field in a DCI format 0 corresponding to an uplink grant, or than the number of bits of the resource allocation field+1 (RA+1).

As a result, by causing the range of j to be smaller than the number of all the resource block groups in FIG. 13, a format of a PDCCH in the case of non-contiguous resource allocation is maintained as in the size of a PDCCH in the case of contiguous resource allocation. Accordingly, there is an advantage in that it is possible to bring about an improvement in throughput according to non-contiguous resource allocation while the number of blind decodings is not increased.

Also, when non-contiguous resources are allocated, a maximum range region which may be set by the start of a first cluster and the end of a last cluster has a maximum range of m. Accordingly, this maximum range can exert a positive influence on an interference problem in an RF (Radio Frequency) specification caused by the transmission of non-contiguous clusters. Namely, as a distance between clusters becomes larger, an interference problem in an RF specification tends to become larger. As described above, by causing a maximum range region, which may be set by the start of a first cluster and the end of a last cluster in the case of non-contiguous resource allocation, to be smaller than the number of all the resource block groups, a distance between clusters becomes shorter. Therefore, there is an advantage in that an interference problem in an RF specification is solved.

Although the above description is only an illustrative description of the technical idea of the present invention, those having ordinary knowledge in the technical field of the present invention will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the technical idea of the present invention is not limited by the embodiments. The protection scope of the present invention should be construed based on the accompanying claims, and all of the technical ideas included within the scope equivalent to the claims should be construed as being included within the right scope of the present invention.

1. A method for allocating resources by a base station, the method comprising:
non-contiguously allocating resources of a k (k is a natural number equal to or greater than 2) number of clusters each including one or more resource block groups among all resource block groups to a user equipment in a wireless communication system; and
generating a message indicating a k number of non-contiguous clusters by using at least one offset and one of at least one length of a resource block group and at least one different offset.

2. The method as claimed in claim 1, wherein the message is included in a control channel, and the control channel including the message is transmitted.

3. The method as claimed in claim 2, wherein the control channel includes a resource allocation field, and the resource allocation field comprises a resource indicator indicating two or more non-contiguous clusters.

4. The method as claimed in claim 3, wherein the resource indicator is expressed by a 2k number of offsets, and two pairs among the 2k number of offsets express a start point and an end point of a particular cluster, respectively.

5. The method as claimed in claim 3, wherein the resource indicator is constructed from a k number of offsets and lengths of a k number of resource block groups.

6. The method as claimed in claim 1, wherein the message includes a resource indicator indicating non-contiguous clusters expressed by
RIV(x₁,x₂, . . .xₖ,n)=RIV₁(x₁,n)+RIV₂(x₁,x₂,n)+ . . .+RIVₖ(x₁,x₂, . . . ,xₖ,n),
wherein x₁, x₂, . . . , and xₖ signify at least one of an offset, a length of resource block groups, and a start point or an end point of a particular cluster, n signifies the number of all resource block groups, RIV₁(x₁, n) signifies a function of x₁ and n, RIV₂(x₁, x₂,n) signifies a function of x₁, x₂ and n, and RIV(x₁, x₂, . . . , xₖ, n) signifies a function of x₁, x₂, . . . , xₖ, and n.

7. The method as claimed in claim 6, wherein in RIV(x₁, x₂, . . . , xₖ, n)=RIV₁(x₁, n)+RIV₂(x₁, x₂, n)+ . . . +RIVₖ(x₁, x₂, . . . , xₖ, n), some calculated values of one or more of RIV₁ to RIVₖ are replaced by a resource indication value (RIV) in a case of contiguous resource allocation, which indicates a start point of a resource block group (a starting resource block RBₛₜₐᵣₜ) and the length of contiguous virtual resource blocks (a length L_{CRBs} in terms of virtually contiguously-allocated resource blocks).

8. The method as claimed in claim 3, wherein k is 2:and the resource indicator indicates an offset y of resource block groups within an entire region including two clusters and a region of resource block groups which are not allocated as resources, a length x of the entire region, and another offset w and another length z of the region of the resource block groups between the two clusters, which are not allocated as resources.

9. The method as claimed in claim 8, wherein the resource indicator is expressed by
RIV(2)=RIV₁(x,n)+RIV₂(x,y)+RIV₃(x,z)+RIV₄(w),
and
RIV=0, . . . ,ₙ₋₁C₄−1
wherein RIV(2) signifies a resource indicator value (RIV) of a resource allocation field in a case of allocating non-contiguous resources of two non-contiguous clusters, RIV₁(x, n) signifies a function of x and n corresponding to the number of all the resource block groups, RIV₂(x, y) signifies a function of x and y, RIV₃(x, z) signifies a function of x and z, and RIV₄(w) signifies a function of w.

10. The method as claimed in claim 3, wherein k is 3, and the resource indicator indicates an offset of resource block groups within an entire region including three clusters and a region of resource block groups which are not allocated as resources, a length of the entire region, and offsets y and w, and lengths x and z representing the region of the resource block groups within the entire region, which are not allocated as resources.

11. The method as claimed in claim 10, wherein the resource indicator is expressed by
RIV(3)=RIV₁(a,n)+RIV₂(a,b)+RIV₃(x,a−2)+RIV₄(x,y)+RIV₅(x,z)+RIV₆(w),
and
RIV=0, . . . ,ₙ₋₁C₆−1
wherein RIV₁(a, n) signifies a function of a and n corresponding to the number of all the resource block groups, RIV₂(a, b) signifies a function of a and b, RIV₃(x, a−2) signifies a function of x and (a−2), RIV₄(x, y) signifies a function of x and y, RIV₅(x, z) signifies a function of x and z, and RIV₆(w) signifies a function of w.

12. The method as claimed in claim 6, wherein, when the number of the non-contiguous clusters is k, a range from a start point of a first cluster to an end point of a last cluster has a value from (2k−1) to m ((2k−1)=m<n).

13. The method as claimed in claim 12, wherein a value of m is determined in such a manner that a value of a binary number expressing a calculated value of all cases of a range possessed by all clusters with respect to clusters, the number of which is 2 to k is equal to or less than the number of bits (RA) of a resource allocation field, or than the number of bits of the resource allocation field+1 (RA+1).

14. A method for allocating resources by a base station, the method comprising:
contiguously or non-contiguously allocating resources of a k (k is a natural number equal to or greater than 2) number of clusters each including one or more resource block groups among all resource block groups to a user equipment in a wireless communication system; and
generating information on contiguous or non-contiguous resource allocation, which is constructed by one number system.

15. The method as claimed in claim 14, wherein
the resource allocation information is expressed by
RIVₜₒₜₐₗ(k)=Σᵢ₌₁^{k-1}RIV^{max}(i)+RIV(k)
wherein RIV(k) corresponds to resource allocation information having a k number of clusters, and RIV^{max}(i) represents a maximum value of resource allocation information having an i number of clusters.

16. The method as claimed in claim 15, wherein k=2, and the resource allocation information is expressed by
$${RIV}_{total} ( 2 ) = \{ \begin{matrix}{RIV}_{LTE} ( z , w , n ) & ( contiguous ) \\ RIV ( 2 ) + \frac{n ( n + 1 )}{2} & ( non \text{-} contiguous )\end{matrix} \\ or \\ {RIV}_{total} ( 2 ) = \{ \begin{matrix}{RIV}_{LTE} ( z , w , {n}^{′} ) & ( contiguous ) \\ RIV ( 2 ) + \frac{{n}^{′} ( {n}^{′} + 1 )}{2} & ( non \text{-} contiguous ) ,\end{matrix}$$
wherein RIV_{LTE}(z, w, n) corresponds to resource allocation information in a case of contiguous resource allocation, RIV(2) corresponds to resource allocation information in a case of non-contiguous resource allocation, z signifies z=L_{CRBs}, w signifies w=RBₛₜₐᵣₜ, n′ signifies n′=N_{RB}^{DL}, and n signifies n=_{RBG}^{DL}.

17. A method for transmitting control information by a base station, the method comprising:
adding a cyclic redundancy check (CRC) for error detection to control information including resource allocation information expressed by RIV(x₁, x₂, . . . , xₖ, n), wherein x₁, x₂, . . . , and xₖ signify at least one of an offset, a length of resource block groups, and a start point or an end point of a particular cluster, and n signifies the number of all resource block groups;
generating coded data by channel-coding the control information to which the CRC is added;
generating modulation symbols by modulating the coded data; and
mapping the modulation symbols to physical resource elements, and transmitting the modulation symbols mapped to the physical resource elements to a user equipment.

18. A method for processing control information by a user equipment, the method comprising:
demapping received physical resource elements to symbols;
demodulating demapped symbols and generating data;
channel-decoding the demodulated data, and detecting whether an error has occurred, by performing a cyclic redundancy check (CRC) check on the channel-decoded demodulated data;
acquiring control information by removing the CRC from the decoded data; and
interpreting resource allocation information expressed by RIV(x₁, x₂, . . . , xₖ, n) from the acquired control information, wherein x₁, x₂, . . . , and xₖ signify at least one of an offset, a length of resource block groups, and a start point or an end point of a particular cluster, and n signifies the number of all resource block groups.
